(19) United States
(12) Patent Application Publication
(10) Pub. No.: US 2015/0180382 A1
(43) Pub. Date: Jun. 25, 2015

(54) MOTOR CONTROL DEVICE

(71) Applicant: Panasonic Intellectual Property Management Co., Ltd., Osaka-shi, Osaka (JP)

(72) Inventors: Yuji Hamada, Hyogo (JP); Kenji Sugiura, Kanagawa (JP)

(21) Appl. No.: 14/409,370

(22) PCT Filed: Aug. 5, 2013
(86) PCT No.: PCT/JP2013/004721

§ 371 Date: Dec. 18, 2014

(30) Foreign Application Priority Data
Aug. 8, 2012 (JP) 2012-175702

(51) Int. Cl. H02P 6/00

(52) U.S. Cl. CPC H02P 6/002

(57) ABSTRACT

A motor control device of the present invention includes an inverter having one side coupled to a dc power supply, and another side coupled to a motor provided with drive windings of multiple phases, a current detector disposed between the dc power supply and the inverter, and a control circuit for detecting an electric current that flows through the drive windings by converting an inverter bus current detected by the current detector, and outputting PWM signals of multiple phases to a plurality of switching element pairs provided in the inverter. The control circuit generates the PWM signals by applying a current-detection PWM signal for detecting the inverter bus current to a motor-drive PWM signal for driving the motor.

### TECHNICAL FIELD

The present invention relates to a motor control device that efficiently drives a brushless dc motor and the like.

### BACKGROUND ART

Recently, there is strong demand for reduction of power consumption of various electric apparatuses in the light of the global environmental protection. As one of the techniques of reducing power consumption, inverter control and the like method is widely used, in which motors of high efficiency are driven at any of selected frequencies. The motors of high efficiency include brushless direct current (“dc”) motors. Such a brushless dc motor may be referred to hereinafter as “motor”. As a technical method of driving motor, there is a rectangular-wave drive method in which the motor is driven by an electric current of rectangular waveform. Also available is a sine-wave drive method that is higher in efficiency than the rectangular-wave drive method, and capable of reducing noises. The sine-wave drive method, in particular, is receiving attention.

In order to drive a brushless dc motor efficiently by the sine-wave drive method, it is necessary to properly control phases of winding currents flowed to the brushless dc motor. The winding current may be referred to hereinafter simply as “electric currents” or “currents”. To properly control the phases of the winding currents, it is necessary to detect the winding currents of at least two phases among the three phases included in the motor. There is a one-shunt current detection method proposed as the current detection method for detecting electric currents of the two phases with a low cost.

FIG. 11 is a schematic diagram that shows a circuit configuration of a conventional motor control device. As shown in FIG. 11, the motor control device using the conventional one-shunt current detection method comprises inverter 23, dc power supply 25 and current detector 22.

A single unit of current detector 22 is disposed between inverter 23 and dc power supply 25. It is possible to detect electric currents of two phases by properly sampling signals from current detector 22 corresponding to PWM signals supplied to inverter 23.

One end of inverter 23 is coupled to a high-voltage side electrode of dc power supply 25, and another end of inverter 23 is coupled to a low-voltage side electrode of dc power supply 25. Inverter 23 has a pair of switching elements for each of the three phases. The pair of switching elements includes a switching element at the high-voltage side and another switching element at the low-voltage side. The switching element at the high-voltage side and the switching element at the low-voltage side are connected in series. Here, the switching element at the high-voltage side is suffixed with letter “H”, and the switching element at the low-voltage side is suffixed with letter “L”. In other words, the pair of switching elements used for U phase includes high-voltage side switching element 23UH and low-voltage side switching element 23UL. Similarly, the pair of switching elements used for V phase includes high-voltage side switching element 23VH and low-voltage side switching element 23VL, and the pair of switching elements used for W phase includes high-voltage side switching element 23WH and low-voltage side switching element 23WL.

FIG. 12 is a graphic illustration showing electrical angles and directions of electric currents fed to motor windings. FIG. 12 shows conditions of phase currents that are fed to the individual phase windings included in motor 21. Also shown in FIG. 12 are directions of the electric currents fed to the individual phase windings in each of equally divided sections having 60 degrees in electrical angle. Here, a direction of the electric currents flowing from inverter 23 to a neutral point of motor 21 is defined as positive, and a direction of the electric currents flowing from motor 21 to inverter 23 is defined as negative, as shown in FIG. 12. In a section of 0 to 60 degrees in the electrical angle, for instance, positive currents are fed to U-phase winding 21U and W-phase winding 21W, and a negative current is fed to V-phase winding 21V. As shown in FIG. 12, the currents of sinusoidal wave are supplied to motor 21. The currents of sinusoidal wave are such that any of the individual phases changes the direction of current flow every 60 degrees in the electrical angle. Because of the current flow of such sinusoidal waveform, motor 21 can be driven efficiently.

The following control is carried out to flow the electric currents of sinusoidal waveform shown in FIG. 12 to motor 21. That is, a driving-voltage command to motor 21 is calculated by driving-voltage command calculator 26 provided in control circuit 24. Based on the computed driving-voltage command, PWM signals are generated to control the individual switching elements. The PWM signals are generated by pulse modulator 27. Inverter 23 is driven by combinations of the PWM signals generated for individual phases shown in FIG. 13.

FIG. 13 is a relational table showing relationship between the PWM signals and phase currents that are detectable in the one-shunt current detection method. In FIG. 13, symbol “0” denotes a low level of the PWM signal. The PWM signal shown by “0” indicates that the corresponding switching element is in an “OFF” state. Symbol “1” denotes a high level of the PWM signal. The PWM signal shown by “1” indicates that the corresponding switching element is in an “ON” state. FIG. 13 shows electric currents of motor 21 that can be detected with current detector 22 according to various combinations of the PWM signals. In the case of the PWM signals of combination (b), for instance, electric current Iw that flows through W phase can be detected. In another instance of the PWM signals of combination (c), electric current Iv that flows through V phase can be detected.

When there is a sufficient separation here from one driving-voltage command to another of the individual phases, it can secure a sustaining time of each state that indicates any of the combinations of the PWM signals. Therefore, an electric current for two of the phases can be detected according to any of the combinations of the PWM signals shown in FIG. 13 while the PWM signals vary in one complete cycle. The one cycle of the PWM signals may be referred to hereinafter as “PWM cycle”.

If the driving-voltage commands for two or three phases are close to each other, however, the sustaining time of each state that indicates any of the combinations of the PWM signals shortens, and this gives rise to a problem that the electric current for two of the phases cannot be detected. A method of solving this problem is disclosed in Patent Literature 1. The method provided in Patent Literature 1 is to correct a pulse-width of the PWM signals in such a period in which the electric current for two of the phases cannot be detected.

FIG. 14A and FIG. 14B show waveforms to help illustrate the PWM method in the conventional one-shunt current detection method.

FIG. 14A and FIG. 14B show waveforms of driving-voltage commands VuS, VvS and VwS of the three phases, and PWM signals UH, VH and WH of the three phases, before and after correction of pulse-widths of the PWM signals.

For each of the PWM signals, a minimum of the sustaining time necessary to accurately detect the electric current is defined as time “t”. The time “t” is the sum of a waiting time needed for the electric current detected with current detector 22 to stabilize after the PWM signal changes and a time needed to obtain a current value of the detected current. It is necessary to maintain the state of the PWM signal (either “1” or “0”) for the duration of sustaining time “t” in order to detect the electric current accurately. There is a case, however, that a PWM signal, the time “t” of which cannot be secured, is generated when two or more values of the driving-voltage commands of three phases become close to each other, as shown in FIG. 14A. Any of the PWM signals not able to secure the time “t”, if generated, makes the electric current undetectable.

The following measure is taken to avoid this kind of situation. Driving-voltage command calculator 26 shown in FIG. 11 determines that it cannot detect an electric current for two phases because the driving-voltage command values of the two phases are close to each other. In this case, driving-voltage command calculator 26 modulates driving-voltage command VwS, for example, in a manner to maintain each combination of the PWM signals only for the duration of time “t” in period T1 of the PWM signals, as shown in FIG. 14B. As a result, a pulse-width of PWM signal WH decreases from 30 to 20. On the other hand, driving-voltage command calculator 26 modulates driving-voltage command VwS to increase the pulse-width of PWM signal WH from 30 to 40 in the next period T2 of the PWM signals.

Thus, the average pulse-width of PWM signal WH remains unchanged at 30 in these two periods of the PWM signals, while securing the time “t” for detecting the electric current, thereby enabling the detection of the electric current reliably. In such application as home appliances of which noises become a problem, it is a general practice here that a frequency of the PWM signals is set at about 16 to 20 kHz so that the noises caused by pulse-width modulation (“PWM”) have no effect in the audio-frequency region. This frequency of the PWM signals may be referred to hereinafter as “PWM frequency”.

### CITATION LIST

### Patent Literature

Patent Literature 1: Japanese Patent Publication, No. 3931079

### SUMMARY OF THE INVENTION

For the purpose of achieving the above object, a motor control device of the present invention is provided with an inverter, a current detector, and a control circuit.

The inverter has one side coupled to a direct current (“dc”) power supply, and another side coupled to a motor equipped with drive windings of multiple phases. The inverter includes a plurality of switching element pairs, each of which has an upper-arm switching element disposed at a high-voltage side of the dc power supply and a lower-arm switching element disposed at a low-voltage side of the dc power supply. Individual connecting points between the upper-arm switching elements and the lower-arm switching elements of the inverter are coupled to the drive windings that form the individual phases of the motor. The inverter applies drive voltages of multiple phases to the drive windings of multiple phases to drive the motor.

The current detector is disposed between the dc power supply and the inverter.

The control circuit detects an electric current that flows through the drive windings by converting an inverter bus current detected by the current detector. The control circuit outputs PWM signals of multiple phases to the plurality of switching element pairs provided in the inverter.

The control circuit generates the PWM signals by applying a current-detection PWM signal for detecting the inverter bus current to motor-drive PWM signal for driving the motor.

### BRIEF DESCRIPTION OF DRAWINGS

FIG. 1 is a schematic diagram that shows a circuit configuration of a motor control device according to a first exemplary embodiment of the present invention.

FIG. 2 shows waveforms to help illustrate a PWM method in a one-shunt current detection method according to the first exemplary embodiment of the invention.

FIG. 3A is a schematic diagram to help illustrate an electric current that flows through a current detector according to the first exemplary embodiment of the invention.

FIG. 3B is another schematic diagram to help illustrate the electric current that flows through the current detector according to the first exemplary embodiment of the invention.

FIG. 3C is another schematic diagram to help illustrate the electric current that flows through the current detector according to the first exemplary embodiment of the invention.

FIG. 3D is still another schematic diagram to help illustrate the electric current that flows through the current detector according to the first exemplary embodiment of the invention.

FIG. 3E is yet another schematic diagram to help illustrate the electric current that flows through the current detector according to the first exemplary embodiment of the invention.

FIG. 4 is a relational table showing motor currents that can be detected by means of a current-detection PWM signal according to the first exemplary embodiment of the invention.

FIG. 5 shows waveforms to help illustrate a PWM method in a one-shunt current detection method according a second exemplary embodiment of the invention.

FIG. 6A is a schematic diagram to help illustrate an electric current that flows through a current detector according to the second exemplary embodiment of the invention.

FIG. 6B is another schematic diagram to help illustrate the electric current that flows through the current detector according to the second exemplary embodiment of the invention.

FIG. 6C is still another schematic diagram to help illustrate the electric current that flows through the current detector according to the second exemplary embodiment of the invention.

FIG. 6D is yet another schematic diagram to help illustrate the electric current that flows through the current detector according to the second exemplary embodiment of the invention.

FIG. 7 is a schematic diagram that shows a circuit configuration of a motor control device according to a third exemplary embodiment of the invention.

FIG. 8A shows waveforms to help illustrate operation of a motor control device when a motor load is small, according to the third exemplary embodiment of the invention.

FIG. 8B shows other waveforms to help illustrate operation of the motor control device when the motor load is small, according to the third exemplary embodiment of the invention.

FIG. 8C shows still other waveforms to help illustrate operation of the motor control device when the motor load is large, according to the third exemplary embodiment of the invention.

FIG. 8D shows yet other waveforms to help illustrate operation of the motor control device when the motor load is large, according to the third exemplary embodiment of the invention.

FIG. 9A shows waveforms to help illustrate a PWM method in a one-shunt current detection method according a third exemplary embodiment of the invention.

FIG. 9B shows other waveforms to help illustrate the PWM method in the one-shunt current detection method according the third exemplary embodiment of the invention.

FIG. 9C shows still other waveforms to help illustrate the PWM method in the one-shunt current detection method according the third exemplary embodiment of the invention.

FIG. 10 is a relational table showing motor currents that can be detected by means of a current-detection PWM signal according to the third exemplary embodiment of the invention.

FIG. 11 is a schematic diagram that shows a circuit configuration of a conventional motor control device.

FIG. 12 is a graphic illustration showing electrical angles and directions of electric currents supplied to motor windings.

FIG. 13 is a relational table showing relationship between PWM signals and phase currents that are detectable in a one-shunt current detection method.

FIG. 14A shows waveforms to help illustrate a PWM method of the conventional one-shunt current detection method.

FIG. 14B shows other waveforms to help illustrate the PWM method of the conventional one-shunt current detection method.

### DESCRIPTION OF EMBODIMENTS

The present invention covers a motor control device capable of stably detecting a motor current from an electric current that flows through a current detector corresponding to current-detection PWM signals, as will be disclosed in each of the following exemplary embodiments. The current-detection PWM signals to be applied are of same duration for all three phases, and there is thus no shift to occur in voltages applied to drive windings of a motor. Because there is no shift in the voltages applied to the drive windings of the motor, it is no need to correct the drive voltages anew. It thus becomes possible to suppress noise attributed to frequency components of low order in the PWM signals, and to avoid a problem of the noise in the audio-frequency region.

In other words, the motor control device having a simple structure is yet capable of suppressing the noise attributed to the frequency components of low order in the frequency of the PWM signals.

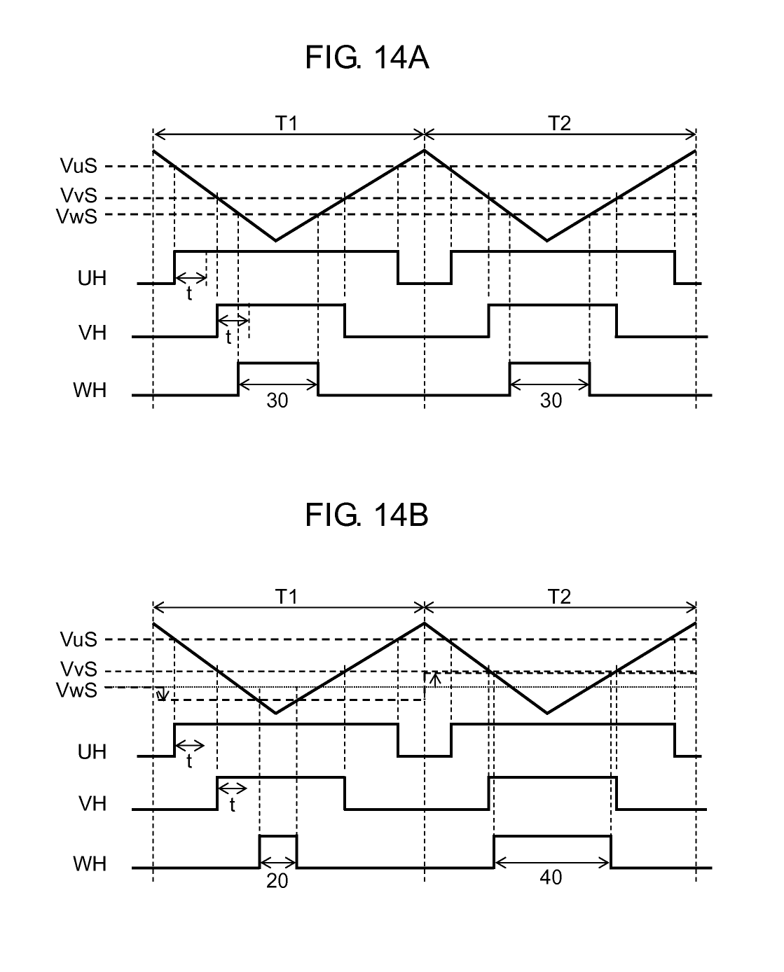

In other words, the conventional method of controlling a motor has the following matters to be improved. That is, a value of driving-voltage command is modulated to correct pulse-widths during two cycles of the PWM signals, as shown in FIG. 14. When the pulse-widths of the PWM signals are corrected, that is, the pulse-widths of the PWM signals are increased or decreased, there occurs a component that changes at two cycles of the PWM signals. This produces noise of a component equal to one-half of a PWM frequency. When the PWM frequency is set at 20 kHz, for instance, the noise having a frequency of 10 kHz is produced. Since the frequency of 10 kHz is inside the audio-frequency region, a countermeasure to this noise is required. When a value directed by the driving-voltage command is small, in particular, voltage levels for the individual phases come close to one another. As driving-voltage command is therefore modulated frequently, the pulse-widths of the PWM signals are corrected frequently. If the pulse-widths of the PWM signals are corrected frequently, the problem of noise becomes more liable to occur.

Referring to the accompanying drawings, description will be provided hereinafter about a three-phase brushless dc motor for which the invention demonstrates especially a prominent effect.

The exemplary embodiments described herein should be considered as a few embodied examples, and not intended to limit the technical scope of the present invention.

In addition, same reference marks are used to designate same components as those described in the Background Art, and their details will be quoted from the same.

### First Exemplary Embodiment

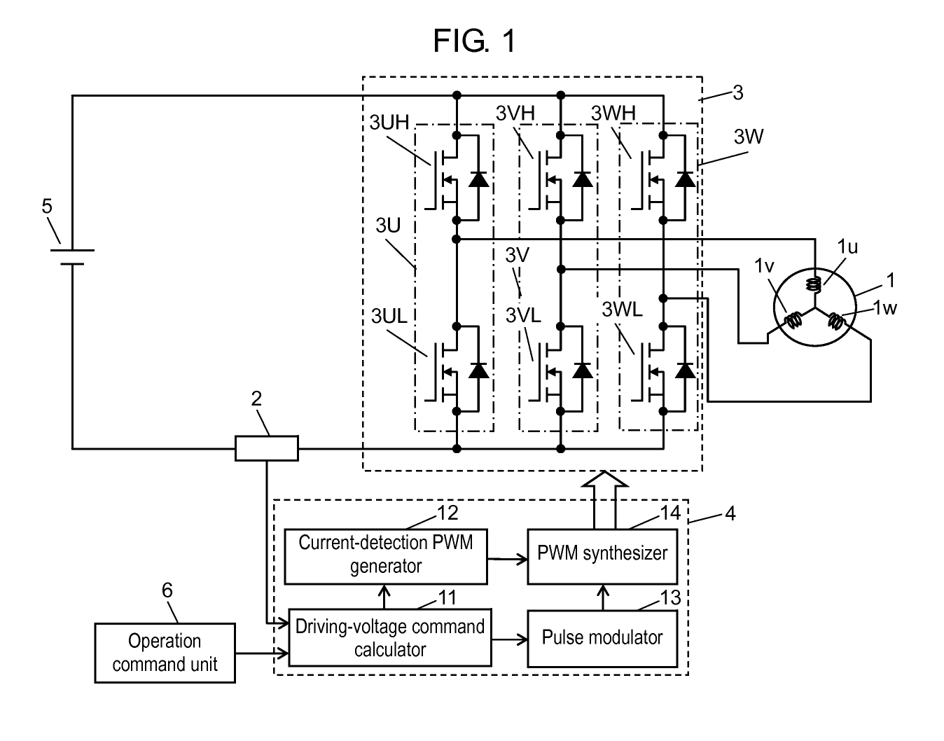

FIG. 1 is a schematic diagram that shows a circuit configuration of a motor control device according to the first exemplary embodiment of the present invention. As shown in FIG. 1, the motor control device in the first embodiment of this invention is provided with inverter 3 coupled to dc power supply 5, current detector 2, and control circuit 4.

Inverter 3 has one side coupled to dc power supply 5, and another side coupled to motor 1 equipped with drive windings of multiple phases. Inverter 3 includes a plurality of switching element pairs, each of which has an upper-arm switching element disposed at a high-voltage side of dc power supply 5 and a lower-arm switching element disposed at a low-voltage side of the dc power supply. Individual connecting points between the upper-arm switching elements and the lower-arm switching elements of inverter 3 are coupled to the drive windings that form the individual phases of motor 1. Inverter 3 drives motor 1 by applying drive voltages of multiple phases to the drive windings of multiple phases.

Current detector 2 is disposed between dc power supply 5 and inverter 3.

Control circuit 4 includes driving-voltage command calculator 11, current-detection PWM generator 12, pulse modulator 13, and PWM synthesizer 14.

Control circuit 4 detects an electric current that flows through the drive windings by converting an inverter bus current detected by current detector 2. Control circuit 4 outputs PWM signals of multiple phases to the plurality of switching element pairs provided in inverter 3.

Control circuit 4 generates the PWM signals by applying current-detection PWM signals for detecting the inverter bus current to motor-drive PWM signals for driving motor 1.

In addition, the motor control device in the first embodiment of this invention may be provided with the following feature. That is, control circuit 4 applies the current-detection PWM signals to the motor-drive PWM signals in a manner to avoid the drive voltages from becoming unbalanced through one full cycle of the PWM signals.

In particular, the motor control device in the first embodiment of this invention may have the following feature. That is, control circuit 4 applies the current-detection PWM signals to the motor-drive PWM signals phase by phase in a sequential manner and in such timing that they do not cause changes in the PWM signals of other phases.

Description is provided in further details by referring to FIG. 1.

Inverter 3 is provided with the switching element pairs of three phases. Switching element pair 3U of U phase has upper-arm switching element 3UH and lower-arm switching element 3UL. Upper-arm switching element 3UH is coupled to dc power supply 5, and disposed at the high-voltage side of dc power supply 5. Lower-arm switching element 3UL is coupled to dc power supply 5, and disposed at the low-voltage side of dc power supply 5. Upper-arm switching element 3UH and lower-arm switching element 3UL are connected in series. A connecting point between upper-arm switching element 3UH and lower-arm switching element 3UL is coupled to drive winding 1u that forms the U phase of motor 1. The drive winding of the motor may be hereinafter referred to as “winding”. Inverter 3 applies a drive voltage of the U phase to drive winding 1u of the U phase.

Similarly, switching element pair 3V of V phase has upper-arm switching element 3VH and lower-arm switching element 3VL. Upper-arm switching element 3VH is coupled to dc power supply 5, and disposed at the high-voltage side of dc power supply 5. Lower-arm switching element 3VL is coupled to dc power supply 5, and disposed at the low-voltage side of dc power supply 5. Upper-arm switching element 3VH and the lower-arm switching element 3VL are connected in series. A connecting point between upper-arm switching element 3VH and lower-arm switching element 3VL is coupled to drive winding 1v that forms the V phase of motor 1. Inverter 3 applies a drive voltage of the V phase to drive winding 1v of the V phase.

Furthermore, switching element pair 3W of W phase has upper-arm switching element 3WH and lower-arm switching element 3WL. Upper-arm switching element 3WH is coupled to dc power supply 5, and disposed at the high-voltage side of dc power supply 5. Lower-arm switching element 3WL is coupled to dc power supply 5, and disposed at the low-voltage side of dc power supply 5. Upper-arm switching element 3WH and the lower-arm switching element 3WL are connected in series. A connecting point between upper-arm switching element 3WVH and lower-arm switching element 3WL is coupled to drive winding 1w that forms the W phase of motor 1. Inverter 3 applies a drive voltage of the W phase to drive winding 1w of the W phase.

Inverter 3 applies the drive voltages of the individual phases to their corresponding windings of the U phase, V phase and W phase to drive motor 1.

Current detector 2 is connected between dc power supply 5 and inverter 3. Current detector 2 detects an inverter bus current. An electric current flowed to each of drive windings 1u, 1v and 1w can be detected by converting the inverter bus current. The electric current flowed to drive windings 1u, 1v and 1w may be hereinafter referred to as “motor current”. Inverter 3 applies the drive voltages of individual phases according to the PWM signals output from control circuit 4, and drives motor 1.

Control circuit 4 includes driving-voltage command calculator 11, current-detection PWM generator 12, pulse modulator 13 and PWM synthesizer 14.

Driving-voltage command calculator 11 calculates a driving-voltage command based on a value of the inverter bus current detected by current detector 2, and instruction of a command from operation command unit 6.

Pulse modulator 13 converts the driving-voltage command into a motor-drive PWM signals.

Current-detection PWM generator 12 generates current-detection PWM signals.

PWM synthesizer 14 generates PWM signals by combining the motor-drive PWM signals and the current-detection PWM signals.

The generated PWM signals for three phases are output to inverter 3 from PWM synthesizer 14. To be precise, the PWM signals for the three phases are output to switching element pairs 3U, 3V and 3W of the corresponding phases.

The motor control device of the first embodiment operates in a manner as described below by presenting a case of the electrical angle between 120 and 180 degrees.

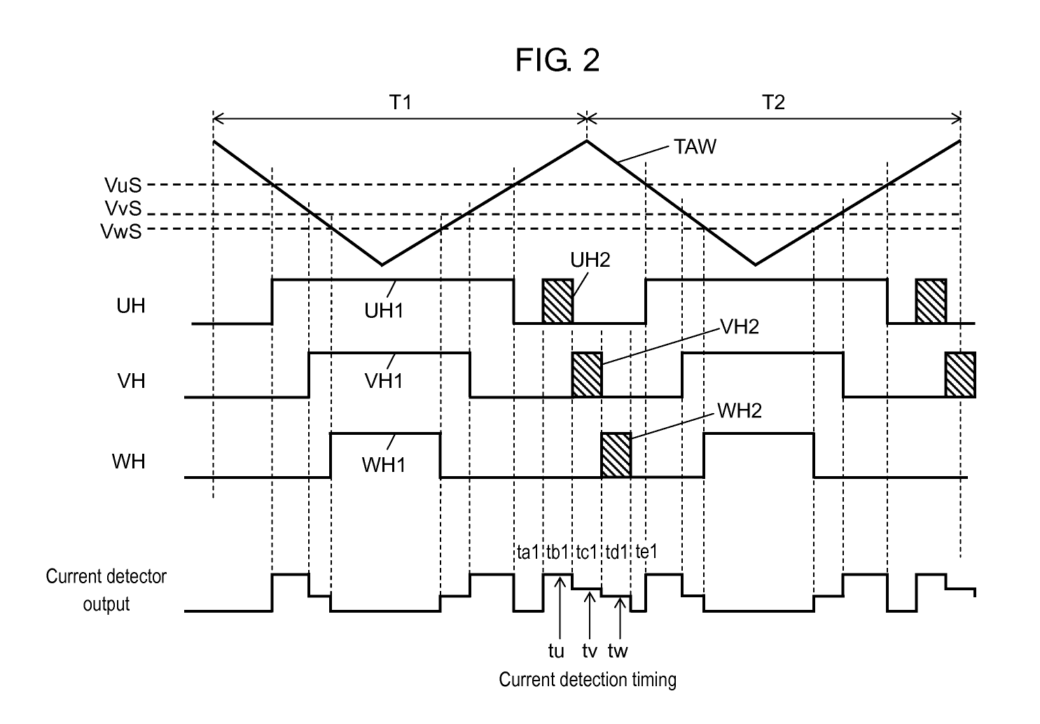

FIG. 2 shows waveforms to help illustrate the PWM method in the one-shunt current detection method according to the first embodiment of this invention. In the motor control device on this first embodiment, motor-drive PWM signals UH1, VH1 and WH1 and current-detection PWM signals UH2, VH2 and WH2 shown as diagonally-shaded areas are combined to generate PWM signals UH, VH and WH, as shown in FIG. 2. The generated PWM signals UH, VH, and WH are output from control circuit 4 to inverter 3, as shown in FIG. 1. Motor 1 is driven by these PWM signals UH, VH and WH.

Motor drive PWM signals UH1, VH1 and WH1 are determined as a result of comparing driving-voltage commands VuS, VvS and VwS with triangle wave TAW. Current-detection PWM signals UH2, VH2 and WH2 have duration of time that is necessary to detect the electric current.

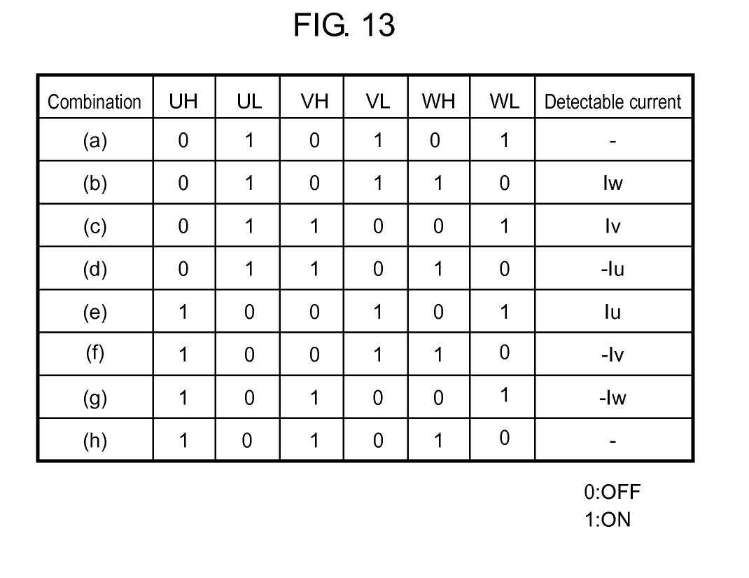

In the first embodiment, current-detection PWM signals UH2, VH2 and WH2 are applied to motor-drive PWM signals UH1, VH1 and WH1 in the timings when all of them are in a low level. Description is given by referring to FIG. 13. The timing in which all of motor-drive PWM signals UH1, VH1 and WH1 become a low level (“0”) is shown in row (a) of FIG. 13. This timing is called “timing of same polarity”.

In other words, current-detection PWM signals UH2, VH2 and WH2 of the same pulse-width are applied to corresponding motor-drive PWM signals UH1, VH1 and WH1 of U phase, V phase and W phase in a sequential manner and in such timing that they do not cause changes in the PWM signals of other phases among signals UH, VH and WH.

Therefore, the PWM signals thus generated differ momentarily from PWM signals to be generated based on a value of the driving-voltage command as required to carry out desirable driving operation of the motor. Although the PWM signals differ from what are originally intended to generate, they do not influence upon the motor torque since their pulse-width is short. In addition, an average voltage of the PWM signals in one full cycle comes to conform to the driving-voltage command necessary to carry out the desirable driving operation of the motor.

In other words, the current-detection PWM signals are applied to the motor-drive PWM signals in a manner to avoid the drive voltages from becoming unbalanced through one full cycle of the PWM signals.

PWM signals UL, VL and WL, although not shown in FIG. 2, are inverted signals of the PWM signals UH, VH and WH respectively.

Description is provided here about the electric current that flows through current detector 2 in periods ta1 to te1 that include fore and aft of a period in which current-detection PWM signals UH2, VH2 and WH2 shown in FIG. 2 are applied.

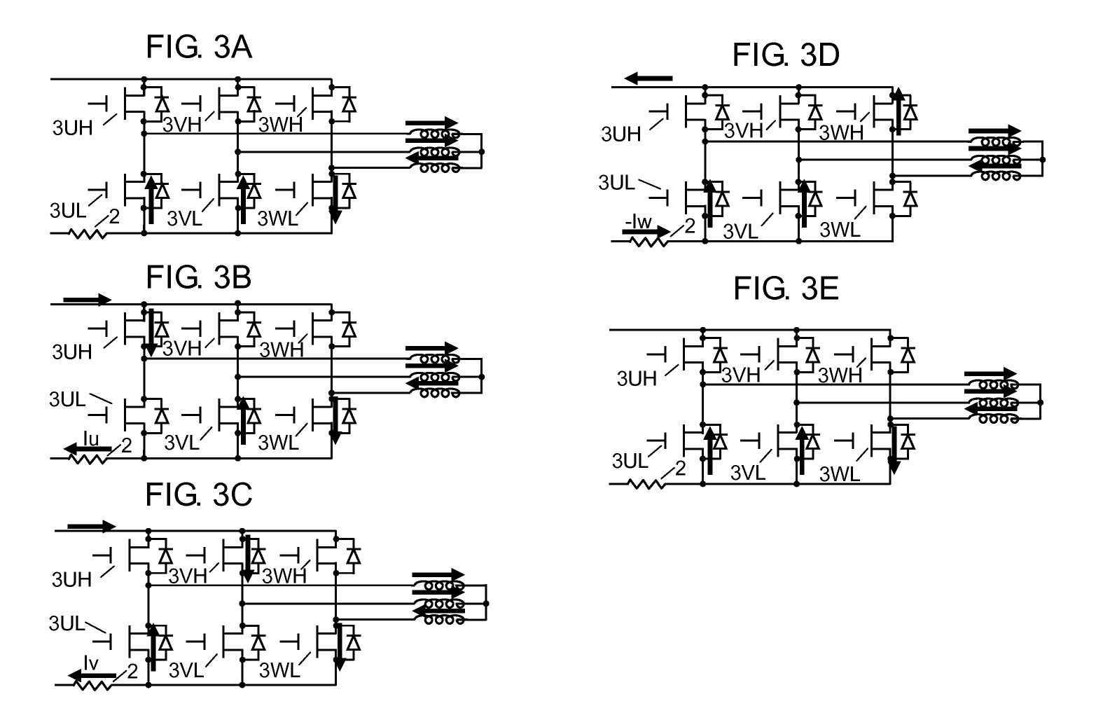

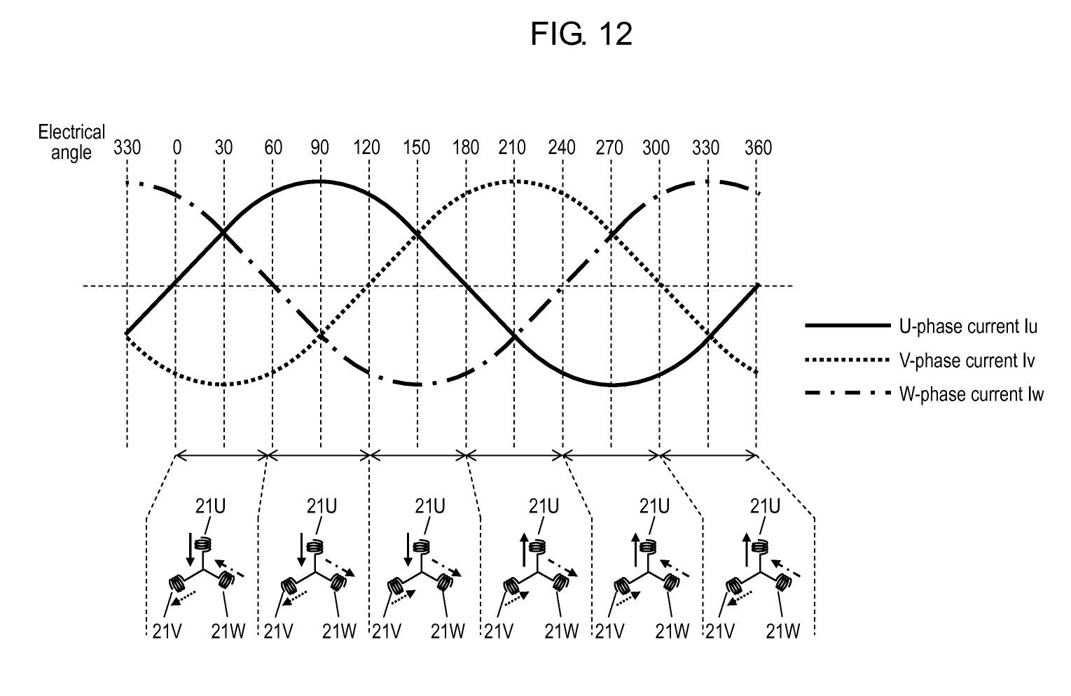

FIG. 3A to FIG. 3E show electric currents that flow through current detector 2. That is, FIG. 3A to FIG. 3E are schematic diagrams to help illustrate the electric currents that flow through the current detector according to the first embodiment of this invention. Each of FIG. 3A to FIG. 3E corresponds to respective one of the periods ta1 to te1 shown in FIG. 2. FIG. 12 and FIG. 13 are also referred to in the description provided below.

As shown in FIG. 12, control circuit 4 carries out control in such a manner that a positive current flows to both U-phase winding 1u and V-phase winding 1v between the electrical angle of 120 and 180 degrees. Control circuit 4 carries out control at the same time so that a negative current flows to W-phase winding 1w.

In the period ta1, all of PWM signals UH, VH and WH are in a low level (“0”), as shown in FIG. 2. As discussed above, PWM signals UL, VL and WL are inverted signals of the PWM signals UH, VH and WH respectively. Therefore, all the PWM signals UL, VL and WL become a high level (“1”). Hence, the lower-arm switching elements 3UL, 3VL and 3WL turn on. This state is shown in FIG. 3A, and current detector 2 detects no electric current, as shown in FIG. 3A.

In the period tb1, the PWM signals UH, VL and WL become a high level (“1”), as shown in FIG. 2. Thus, upper-arm switching element 3UH and lower-arm switching elements 3VL and 3WL turn on. This state is shown in FIG. 3B, and current detector 2 detects U-phase current Iu, as shown in FIG. 3B.

In the similar manner, the PWM signals UL, VH and WL become a high level (“1”) in the period tc1, as shown in FIG. 2. Upper-arm switching element 3VH and lower-arm switching elements 3UL and 3WL hence turn on. This state is shown in FIG. 3C, and current detector 2 detects V-phase current Iv, as shown in FIG. 3C.

In the period td1, the PWM signals UL, VL and WH become a high level (“1”), as shown in FIG. 2. Upper-arm switching element 3WH and lower-arm switching elements 3UL and 3VL hence turn on. This state is shown in FIG. 3D, and current detector 2 detects W-phase current −Iw, as shown in FIG. 3D.

In the period te1, the PWM signals become the same as those in the period ta1, as shown in FIG. 2. That is, all the PWM signals UL, VL and WL become a high level (“1”). Hence, current detector 2 detects no electric current, like the case in the period ta1.

Accordingly, the following fact is known by the application of each of current-detection PWM signals UH2, VH2 and WH2 shown in FIG. 2, in the case of electrical angle between 120 and 180 degrees. That is, the states wherein current-detection PWM signals UH2, VH2 and WH2 shown in FIG. 2 are applied are in timings tu, tv and tw indicated by arrows. These timings tu, tv and tw correspond to the periods tb1, tc1 and td1. It is therefore apparent that U-phase current Iu, V-phase current Iv and W-phase current Iw are detected while the current-detection PWM signals UH2, VH2 and WH2 are applied.

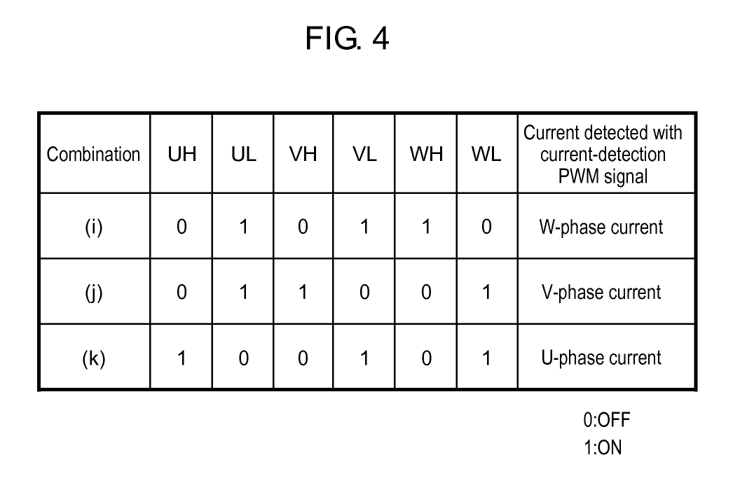

The electric currents detected by application of the current-detection PWM signals are tabulated according to the electrical angles in FIG. 4. FIG. 4 is a relational table showing motor currents that can be detected by using the current-detection PWM signals according to the first embodiment of this invention. Combinations (i), (j) and (k) shown in FIG. 4 correspond to the periods tb1, tc1 and td1 shown in FIG. 2.

According to the first embodiment, as is obvious from the above description, the motor currents can be detected stably during one full cycle of the PWM signals without increasing and decreasing a pulse-width of the motor-drive PWM signals. It is hence possible to suppress the noise attributed to the frequency components of low order in the PWM signals.

By virtue of the first embodiment, the motor currents can be detected stably during one full cycle of the PWM signals by applying the current-detection PWM signals even when values of the driving-voltage commands for two or three phases become close to each other.

As a result, it becomes unnecessary to modulate the driving-voltage commands or to correct the pulse-width in every PWM cycle. Hence achieved is the one-shunt current detection method with the problem of noise suppressed.

What has been described above is one example in which the current-detection PWM signals are applied sequentially in the order of U-phase, V-phase and W-phase as illustrated in FIG. 2. However, the advantageous effects provided by the present invention can be achieved even when the current-detection PWM signals are applies in any other order.

The motor control device in the first embodiment may be operated alternatively in the following manner. That is, the current-detection PWM signals are applied to the three phases in the order of U-phase, V-phase and W-phase, and electric currents are detected only for two of the phases, so that an electric current of remaining one of the phases can be obtained by calculation.

### Second Exemplary Embodiment

Description is provided next of the second exemplary embodiment of the present invention. A motor control device according to the second embodiment has the same circuit configuration as that of the first embodiment shown in FIG. 1.

The motor control device of the second embodiment of the invention has the following features in addition to those of the first embodiment described above.

That is, in the motor control device according to the second embodiment of this invention, PWM signals include three phases.

In particular, control circuit 4 applies current-detection PWM signals in such timing that it does not cause changes in the PWM signals of other phases. Control circuit 4 applies the current-detection PWM signals to the motor-drive PWM signals of two phases in sequential order and in the above timing, such that the current-detection PWM signals are applied independently of the motor-drive PWM signals. Control circuit 4 also applies the current-detection PWM signal to the motor-drive PWM signal of remaining one of the phases in the above timing and in such a manner that the current-detection PWM signal extends an energizing period of the motor-drive PWM signal.

Furthermore, in the motor control device according to the second embodiment of this invention, control circuit 4 outputs the PWM signal of one phase that is generated by applying the current-detection PWM signal after shifting the phase by half a cycle of the PWM signal.

In the case of driving a three-phase motor, it is not necessary to detect motor currents of all the three phases. If motor currents of two phases are detected when driving the three-phase motor, a motor current of the remaining one of the phases can be obtained by calculation.

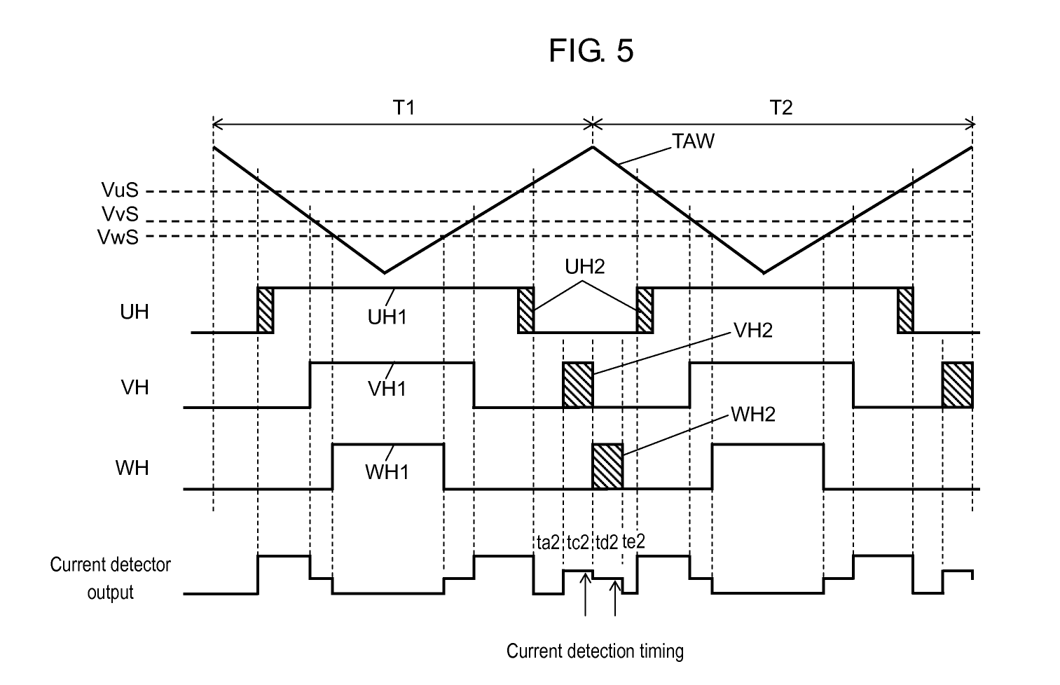

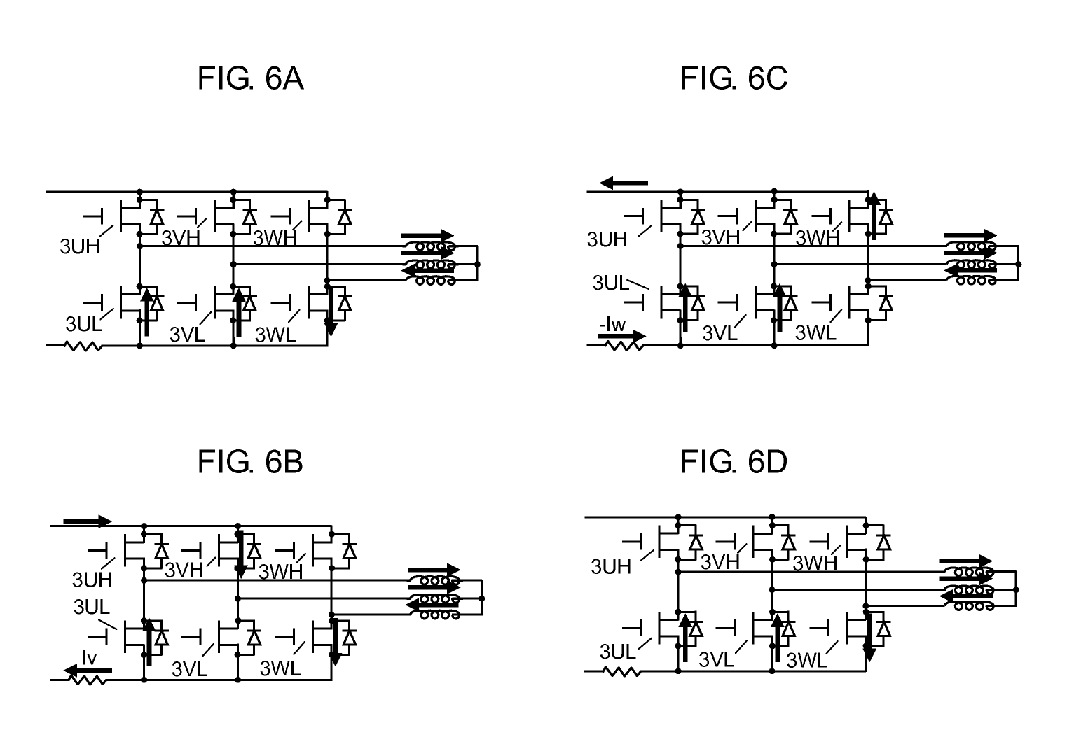

FIG. 5 shows waveforms to help illustrate the PWM method in the one-shunt current detection method according the second embodiment of this invention. FIG. 6A to FIG. 6D are schematic diagrams to help illustrate electric currents that flow through a current detector in the second embodiment of the invention. Each of FIG. 6A, FIG. 6B, FIG. 6C and FIG. 6D corresponds to respective one of periods ta2, tc2, td2 and te2 shown in FIG. 5.

Description is provided hereinafter in detail by referring to the drawings.

As shown in FIG. 5, PWM signals VH and WH are generated corresponding to two phases, i.e., V phase and W phase. These PWM signals VH and WH include motor-drive PWM signals VH1 and WH1, and current-detection PWM signals VH2 and WH2. The motor-drive PWM signals VH1 and WH1 are applied as the PWM signals VH and WH. In addition, current-detection PWM signals VH2 and WH2 are applied to the PWM signals VH and WH, independently of the motor-drive PWM signals VH1 and WH1.

PWM signal UH is generated corresponding to U phase that is the remaining one phase of the three-phase motor. The PWM signal UH includes motor-drive PWM signal UH1 and current-detection PWM signal UH2. The motor-drive PWM signals UH1 is applied as the PWM signal UH. Moreover, current-detection PWM signal UH2 is applied to the PWM signal UH in addition to motor-drive PWM signal UH1.

Here, “current-detection PWM signals are applied independently of the motor-drive PWM signals” means that the signals are applied so that the periods in which both these signals become high levels (“1”) do not overlap with each other.

FIG. 5 illustrates the following state. That is, the current-detection PWM signals VH2 and WH2 are applied sequentially to V phase and W phase independently of the motor-drive PWM signals VH1 and WH1. The current-detection PWM signal UH2 is applied to U phase in a manner to add and extend the motor-drive PWM signal UH1.

In this second embodiment, description is provided of a case of the electrical angle between 120 and 180 degrees, like that of the first embodiment.

Electric currents that are flowed to the individual phases will become apparent from those illustrated in FIG. 5, and FIG. 6A through FIG. 6D.

As shown in FIG. 5, current-detection PWM signal VH2 is applied to V phase in period tc2. FIG. 6B shows states of the individual switching elements in this period. As shown in FIG. 6B, upper-arm switching element 3VH and lower-arm switching elements 3UL and 3WL turn on. As a result, V-phase current Iv is detected in the period tc2 in which the current-detection PWM signal VH2 is being applied.

Next, current-detection PWM signal WH2 is applied to W phase in period td2, as shown in FIG. 5. FIG. 6C shows states of the individual switching elements in this period. As shown in FIG. 6C, upper-arm switching element 3WH and lower-arm switching elements 3UL and 3VL turn on. As a result, W-phase current −Iw is detected in the period td2 in which the current-detection PWM signal WH2 is being applied.

When V-phase current Iv and W-phase current −Iw are detected, U-phase current Iu can be calculated from these results of detection.

In the second embodiment, as is apparent from that described above, the motor currents can be detected stably during one full cycle of the PWM signals by applying the current-detection PWM signals even when values of two or more phases among driving-voltage commands VuS, VvS and VwS become close to each other.

As a result, it becomes unnecessary to modulate the driving-voltage command, or to correct the pulse-width in every PWM cycle. Hence achieved is the one-shunt current detection method with the problem of noise suppressed.

In FIG. 5, as described above, the following current-detection PWM signals are applied to the individual phases. That is, the current-detection PWM signals VH2 and WH2 are applied to V phase and W phase independently of the motor-drive PWM signals VH1 and WH1. The current-detection PWM signal UH2 is applied to U phase, in addition to the current-detection PWM signal UH1.

However, the combination to achieve the second embodiment is not limited to the specific example described above as long as a similar advantageous effect can be provided. Any other combination may also be adoptable to achieve the second embodiment.

### Third Exemplary Embodiment

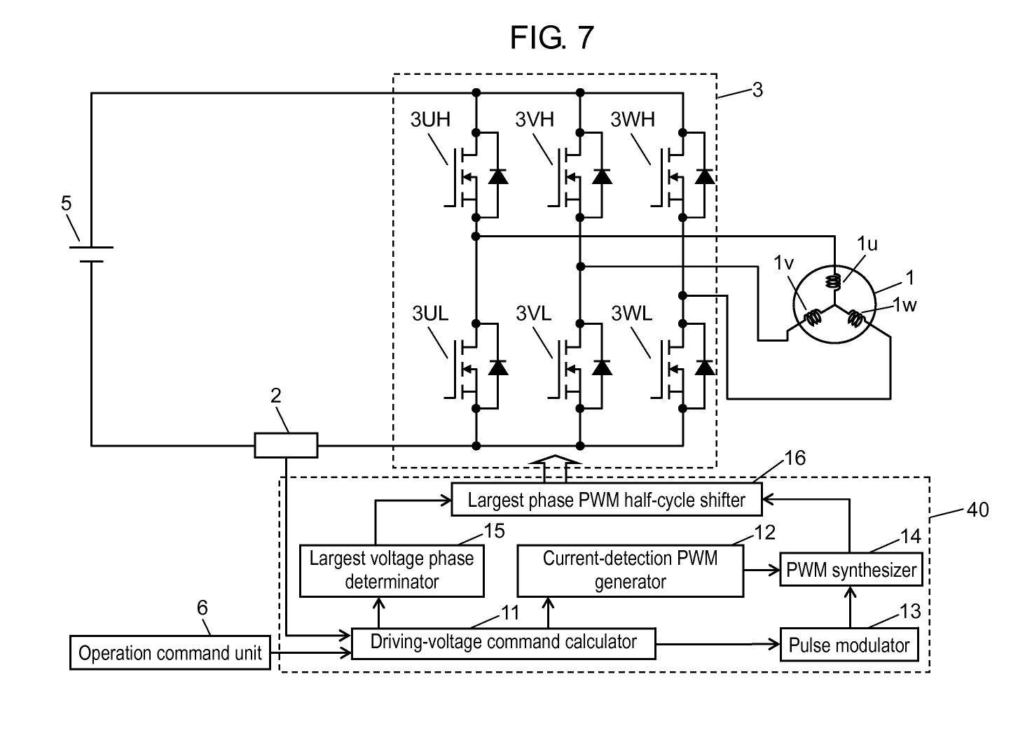

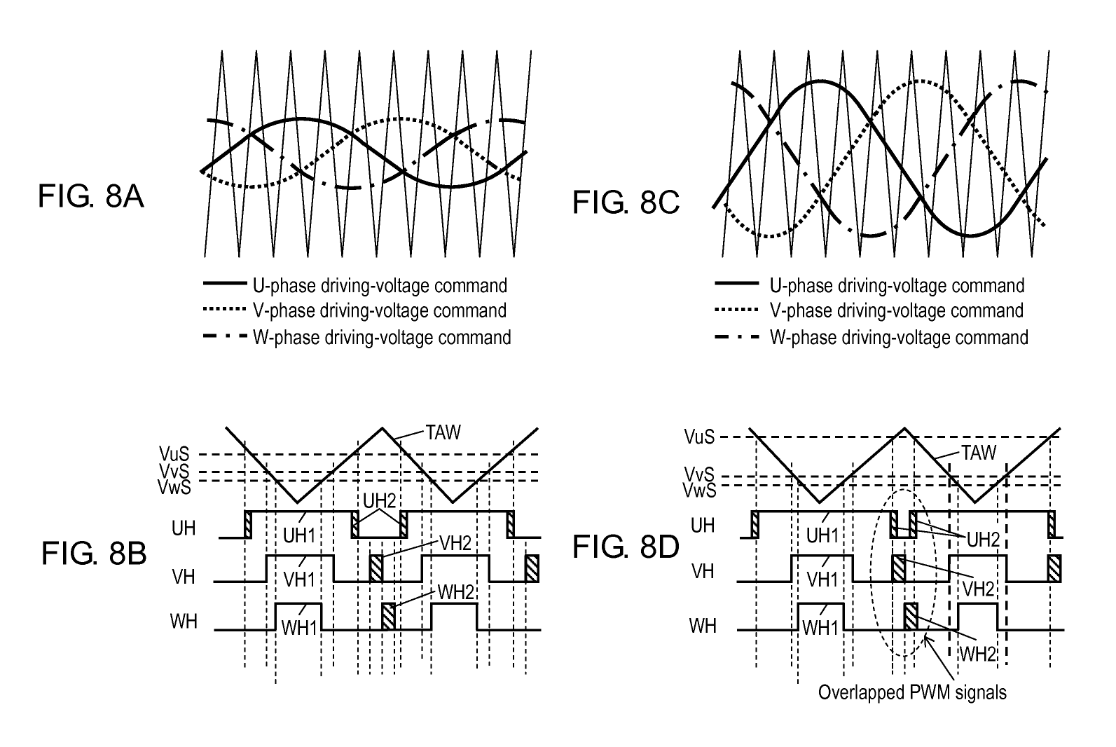

Description is provided next of the third exemplary embodiment of the present invention. FIG. 7 is a schematic diagram that shows a circuit configuration of a motor control device according to the third embodiment of this invention. FIG. 8A to FIG. 8D are drawings of waveforms to help illustrate operation of the motor control device corresponding to motor loads, wherein FIG. 8A and FIG. 8B show waveforms when the motor load is small, and FIG. 8C and FIG. 8D show waveforms when the motor load is large, according to the third embodiment of the invention.

The motor control device according to the third embodiment of this invention has the following features in addition to those of the first and the second embodiments described above.

That is, a PWM signal of one phase, to which a current-detection PWM signal is added, is a largest voltage phase, in the motor control device according to the third embodiment of the invention.

In the motor control device of the third embodiment of this invention, control circuit 40 includes driving-voltage command calculator 11, pulse modulator 13, current-detection PWM generator 12, and PWM synthesizer 14.

Driving-voltage command calculator 11 outputs a driving-voltage command by calculating an operation command and an inverter bus current obtained from the outside of control circuit 40.

Pulse modulator 13 generates motor-drive PWM signals based on the driving-voltage command.

Current-detection PWM generator 12 generates current-detection PWM signals based on the driving-voltage command.

PWM synthesizer 14 generates PWM signals by applying the current-detection PWM signals to the motor-drive PWM signals.

In addition, the motor control device according to the third embodiment of this invention further includes largest voltage phase determinator 15 and largest phase PWM half-cycle shifter 16.

Largest voltage phase determinator 15 determines a largest voltage phase.

Largest phase PWM half-cycle shifter 16 shifts a phase of a PWM signal of largest voltage phase by half a cycle, based on a result of determination by largest voltage phase determinator 15.

Control circuit 40 may be provided with largest voltage phase determinator 15 and largest phase PWM half-cycle shifter 16.

Detailed description is provided hereinafter by referring to the drawings.

In the motor control device of the third embodiment, largest voltage phase determinator 15 and largest phase PWM half-cycle shifter 16 are added to control circuit 4 described in the first and the second embodiments, as shown in FIG. 7.

As discussed in first and the second embodiments, it is necessary to apply the current-detection PWM signals to the motor-drive PWM signals in such timing that they do not cause changes in the PWM signals of other phases. A load imposed on motor 1 increases as illustrated in FIG. 8A and FIG. 8B to that in FIG. 8C and FIG. 8D. When driving-voltage command VuS increases, for instance, a pulse-width of motor-drive PWM signal UH1 increases, as shown in FIG. 8C and FIG. 8D.

In this case, it becomes difficult to output the current-detection PWM signal in the timing that does not cause changes in the PWM signals of other phases. It is therefore not possible to detect the motor current with current detector 2.

The following measure is taken in the third embodiment to avoid this problem.

That is, the motor-drive PWM signal, to which the current-detection PWM signal is added as described in the second embodiment, is appointed as a phase of which the driving-voltage command is determined to be the largest by largest voltage phase determinator 15, according to this third embodiment. Largest voltage phase determinator 15 is shown in FIG. 7.

Largest phase PWM half-cycle shifter 16 outputs a PWM signal of the largest voltage selected by largest voltage phase determinator 15 after shifting its phase by half a cycle. In the third embodiment, the phase of the PWM signal is shifted only by one-half of the cycle. Therefore, it does not change a status of driving operation of motor 1 during one complete cycle of the PWM signal.

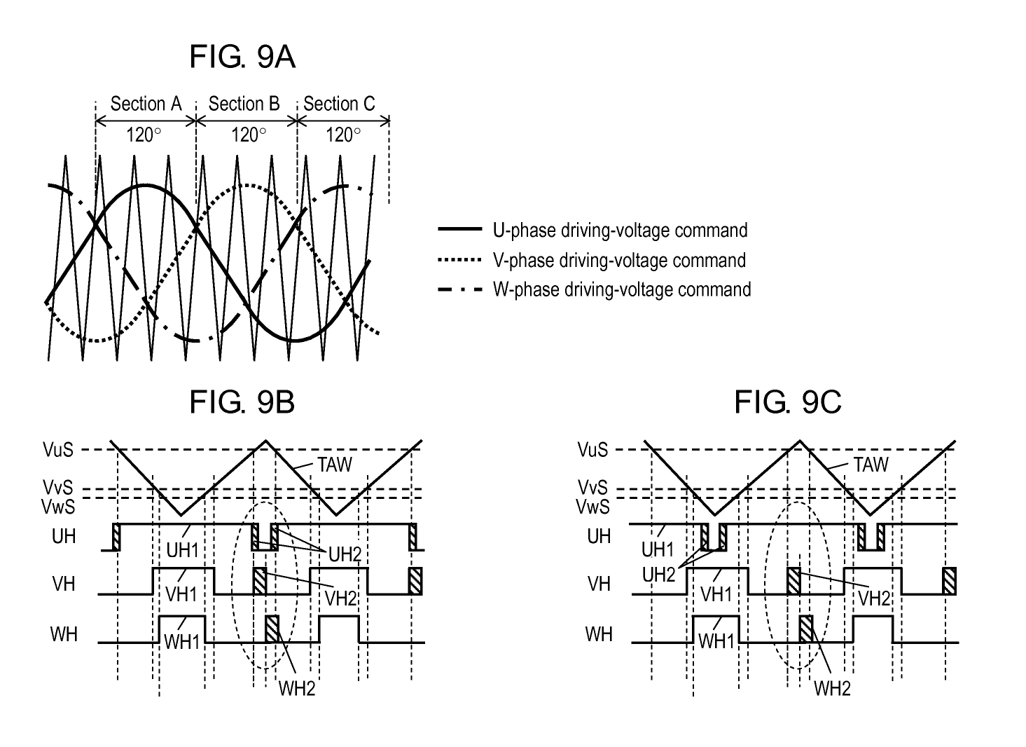

The motor control device of the third embodiment operates in a manner which is described by taking an example of section A shown in FIG. 9A.

FIG. 9A to FIG. 9C are drawings of waveforms to help illustrate operation wherein a three-phase motor is PWM-driven by the one-shunt current detection method adopted in the motor control device according the third embodiment of the invention. In specific, FIG. 9A illustrates waveforms showing driving-voltage commands under a high motor load. FIG. 9B illustrates waveforms of PWM signals before a phase is shifted by half a cycle. FIG. 9C illustrates waveforms of the PWM signals after the phase is shifted by half a cycle.

The largest voltage phase in which the driving-voltage command of motor 1 becomes the largest in section A is U phase. Enlarged PWM signals in this state are shown in FIG. 9B.

As is obvious from FIG. 9B, driving-voltage command VuS is large. Therefore, in case that the current-detection PWM signals are applied in the same manner as the second embodiment, PWM signal UH of U phase changes while current-detection PWM signals VH2 and WH2 of V phase and W phase are being applied. As a result, the electric currents flowed to the V phase and the W phase become undetectable.

According to the third embodiment, PWM signal UH of the U phase that is the largest voltage phase is processed to be shifted by half a cycle of its phase. FIG. 9C shows the state in which the phase of the PWM signal is shifted by half the cycle.

In case that the control method of the second embodiment is used, PWM signal UH is in a low level (“0”) on the crest side of triangle wave TAW, as shown in FIG. 9B. In case that the control method of this third embodiment is used, on the other hand, PWM signal UH is in the low level (“0”) on the trough side of triangle wave TAW, and PWM signal UH is in a high level (“1”) on the crest side of the triangle wave TAW, as shown in FIG. 9C. In other words, it is known that PWM signal UH has a waveform of which the phase is shifted by half its cycle in the third embodiment shown in FIG. 9C, as compared with the second embodiment shown in FIG. 9B.

By adopting the PWM signal of this kind, the PWM signals of other phases including PWM signal UH of U phase remain unchanged even when current-detection PWM signals VH2 and WH2 of V phase and W phase are applied. As a result, the motor currents can be detected stably by current detector 2.

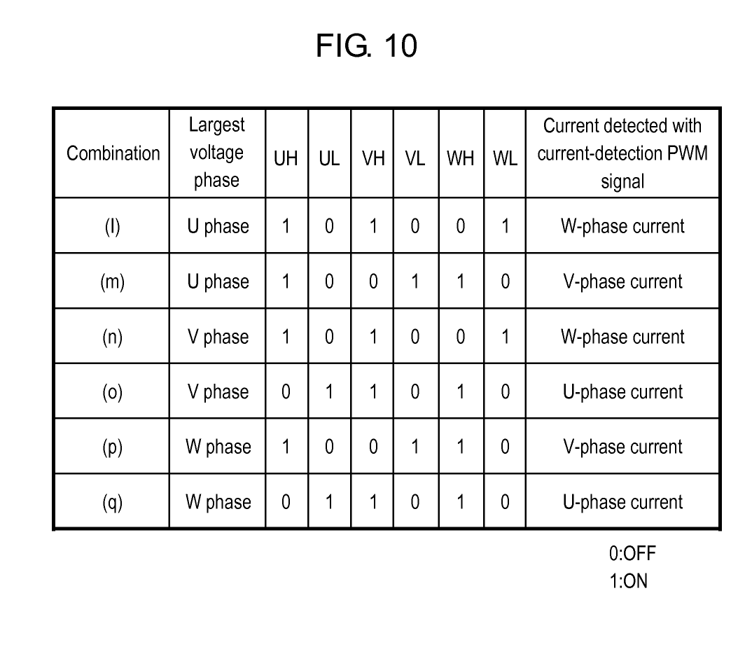

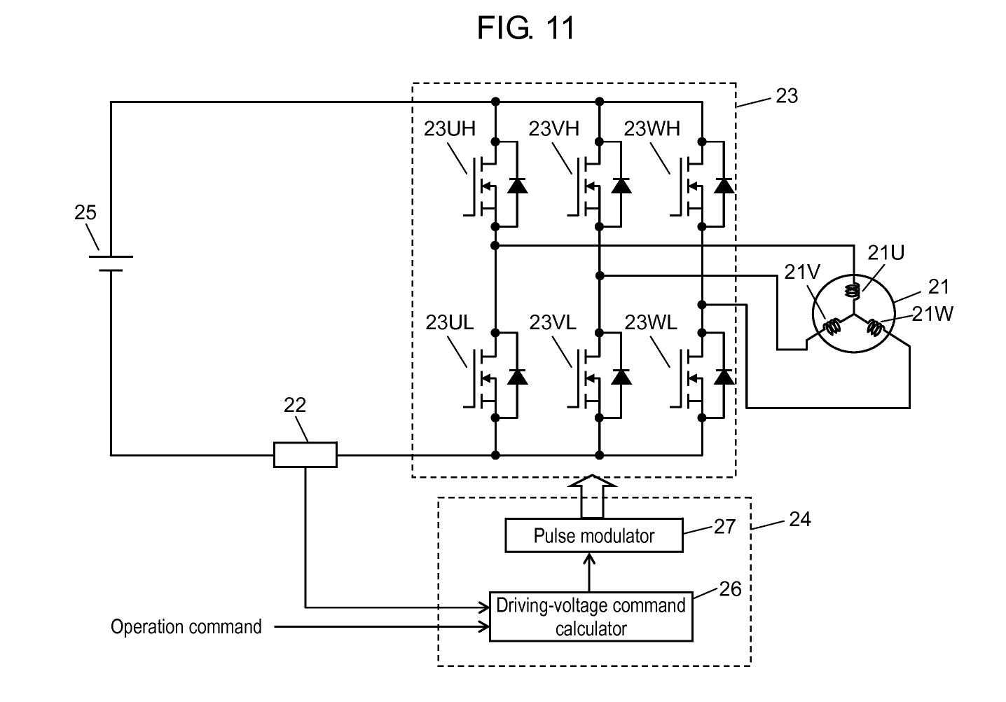

FIG. 10 is a relational table showing the motor currents that can be detected when the current-detection PWM signals of the third embodiment are applied. As shown in FIG. 10, the largest voltage phase changes every 120 degrees in the electrical angle. In this third embodiment, the largest voltage phase is hence determined by using largest voltage phase determinator 15. Based on a result of this determination, selection is made for each of the PWM signals being output as to whether or not the phase is to be shifted by half a cycle.

As shown in FIG. 10, the U phase becomes the largest voltage phase, and a W-phase current can be detected in combination (l). Likewise, the U phase becomes the largest voltage phase, and a V-phase current can be detected in combination (m).

Similarly, the V phase becomes the largest voltage phase, and a W-phase current can be detected in combination (n). Likewise, the V phase becomes the largest voltage phase, and a U-phase current can be detected in combination (o).

Furthermore, the W phase becomes the largest voltage phase, and a V-phase current can be detected in combination (p). Similarly, the W phase becomes the largest voltage phase, and a U-phase current can be detected in combination (q).

According to the third embodiment, as described above, the motor currents can be detected stably during one full cycle of the PWM signals by applying the current-detection PWM signals even when the driving-voltage command value becomes large due to an increase in the motor load.

As a result, it becomes unnecessary to modulate the driving-voltage command, or to correct the pulse-width in every PWM cycle. Hence achieved is the one-shunt current detection method while suppressing the problem of noise with a simple structure.

### INDUSTRIAL APPLICABILITY

According to the motor control device of the present invention, the problem of noise can be suppressed by using the one-shunt current detection method achieved with a structure of even a low cost. The invention is therefore widely useful for other application besides brushless dc motors.

### REFERENCE MARKS IN THE DRAWINGS

1, 21 motor
2, 22 current detector
3, 23 inverter
3U, 3V, 3W switching element pair
3UH, 3VH, 3WH upper-arm switching element
3UL, 3VL, 3WL lower-arm switching element
4, 24, 40 control circuit
5, 25 dc power supply
6 operation command unit
11, 26 driving-voltage command calculator
12 current-detection PWM generator
13, 27 pulse modulator
14 PWM synthesizer
15 largest voltage phase determinator
16 largest phase PWM half-cycle shifter
23UH, 23VH, 23WH high-voltage side switching element
23UL, 23VL, 23WL low-voltage side switching element

1. A motor control device comprising:
an inverter having one side coupled to a dc power supply, and another side coupled to a motor provided with drive windings of multiple phases, wherein
the inverter includes a plurality of switching element pairs, each having an upper-arm switching element disposed at a high-voltage side of the dc power supply and a lower-arm switching element disposed at a low-voltage side of the dc power supply,
a connecting point between the upper-arm switching element and the lower-arm switching element is coupled to each of the drive windings that form individual phases of the motor, and
the inverter applies drive voltages of multiple phases to the drive windings of multiple phases to drive the motor;
a current detector disposed between the dc power supply and the inverter; and
a control circuit for detecting an electric current that flows through the drive windings by converting an inverter bus current detected by the current detector, and outputting PWM signals of multiple phases to the plurality of switching element pairs of the inverter,
wherein the control circuit generates the PWM signals by applying a current-detection PWM signal for detecting the inverter bus current to a motor-drive PWM signal for driving the motor.

2. The motor control device of claim 1, wherein the control circuit applies the current-detection PWM signal to the motor-drive PWM signal in a manner to avoid the drive voltages from becoming unbalanced through one cycle of the PWM signals.

3. The motor control device of claim 2, wherein the control circuit applies the current-detection PWM signal to the motor-drive PWM signal phase after phase in sequential order and in such timing as not to cause changes in the PWM signals of other phases.

4. The motor control device of claim 3, wherein
the PWM signals comprise three phases,
the control circuit applies the current-detection PWM signal to each of the motor-drive PWM signals of two phases in sequential order, the current-detection PWM signal being applied independently of the motor-drive PWM signals, and in the timing not to cause changes in the PWM signals of other phases, and
the control circuit then applies the current-detection PWM signal to the motor-drive PWM signal of remaining one of the phases such that the current-detection PWM signal is applied to extend an energizing period of the motor-drive PWM signal.

5. The motor control device of claim 4, wherein the control circuit outputs the PWM signal of the one of the phases generated by adding the current-detection PWM signal, after shifting a phase by half a cycle of the PWM signal.

6. The motor control device of claim 5, wherein the PWM signal of the one of the phases, to which the current-detection PWM signal is added, is a largest voltage phase.

7. The motor control device of claim 1, wherein the control circuit includes:
a driving-voltage command calculator for outputting a driving-voltage command by calculating an operation command received from outside and the inverter bus current;
a pulse modulator for generating the motor-drive PWM signal based on the driving-voltage command;
a current-detection PWM generator for generating the current-detection PWM signal based on the driving-voltage command; and
a PWM synthesizer for generating the PWM signals by applying the current-detection PWM signal to the motor-drive PWM signal.

8. The motor control device of claim 7 further comprising:
a largest voltage phase determinator for determining a largest voltage phase; and
a largest phase PWM half-cycle shifter for shifting a phase of the PWM signal of the largest voltage phase by half a cycle, based on a determination result of the largest voltage phase determinator.
